(19) United States
(12) Patent Application Publication
(10) Pub. No.: US 2025/0354041 A1
(43) Pub. Date: Nov. 20, 2025

(54) COMPOSITION COMPRISING A SILYLATED POLYMER

(71) Applicant: Bostik SA, COLOMBES (FR)

(72) Inventors: Federico SANZ, VENETTE (FR); David JUSSY, VENETTE (FR)

(21) Appl. No.: 18/864,666

(22) PCT Filed: May 9, 2023
(86) PCT No.: PCT/EP2023/062304

§ 371 Date: Nov. 11, 2024

(30) Foreign Application Priority Data
May 12, 2022 (FR) FR2204514

(51) Int. Cl. C09J 183/06

(52) U.S. Cl. CPC C09J 183/06

(57) ABSTRACT

The invention relates to a composition comprising:
a silyl-modified polymer,
carbon black having an oil absorption number (OAN) of at least 80 ml/100 g, and
a rheological agent.
The invention also relates to the use of the composition according to the invention for adhesive bonding and sealing.

### FIELD OF THE INVENTION

The present invention relates to a composition comprising a silyl-modified polymer, and also to the use thereof, in particular for adhesive bonding and sealing.

### TECHNICAL BACKGROUND

There are various polymer-based compositions on the market, which can be used in many fields, in particular as sealant. Sealants make it possible to assemble (or else to join or attach) two substrates which can be chosen from the most diverse materials, and can also be used as sealing joints. Sealants provide the assembly thus obtained with advantageous mechanical properties of solidity, elasticity and/or flexibility and also fluid tightness.

For example, polymer-based compositions can be used as sealant in building construction, shipbuilding, or the transport sector (for example, road, maritime, rail, or aerospace transport).

Certain applications, in particular the attachment of a glass pane (for example a windshield or window) to the bodywork of a vehicle, require the polymer-based composition to have specific mechanical properties, in particular a high tensile strength and a high elongation at break. Specifically, it is essential that the composition does not break during the impacts to which it is subjected.

The compositions on the market for replacing windshields are usually compositions based on isocyanate-terminated polyurethane, which generally have a high tensile strength and a high elongation at break. At the time the composition is used for producing the assembly, the reaction of the isocyanate reactive groups with water which originates from the moisture in the air or from the substrates to be assembled, is referred to as a crosslinking reaction. It is the completion of this reaction, after a period of time referred to as the crosslinking time, which enables the creation of a solid three-dimensional network which helps to confer the desired mechanical properties on the adhesive joint thus formed.

The compositions based on alkoxysilane-terminated polymer (also referred to as silyl-modified polymer) have the advantage of being free from isocyanates. These compositions thus constitute an alternative, which is preferred from a toxicological viewpoint, to the compositions based on isocyanate-terminated polyurethane.

The crosslinking reaction of these compositions based on silyl-modified polymer takes place, in the presence of moisture, by hydrolysis of the alkoxysilane groups borne by the polymer, followed by their condensation to form a siloxane bond (—Si—O—Si—) which unites the polymer chains in a solid three-dimensional network.

However, it is difficult to obtain a composition, in particular a sealant, based on silyl-modified polymer that has both a high tensile strength and a high elongation at break. Specifically, compositions based on silyl-modified polymer generally have lower tensile strength and elongation at break than compositions based on isocyanate-terminated polyurethane.

There is therefore a need to find a composition comprising a silyl-modified polymer that has improved tensile strength and elongation at break properties, in particular that are similar to compositions based on isocyanate-terminated polyurethane.

### SUMMARY OF THE INVENTION

The present invention relates to a composition comprising:
a silyl-modified polymer,
carbon black having an oil absorption number (OAN) of at least 80 ml/100 g, and
a rheological agent.

Another subject of the present invention is a process for assembling two substrates by adhesive bonding, comprising:
the coating, onto at least one of the two substrates to be assembled, of the composition according to the invention, as defined previously; then
actually bringing the two substrates into contact.

The present invention also relates to an article capable of being obtained according to the assembly process as defined above, preferably a vehicle.

The present invention also relates to a vehicle comprising a composition as defined in the present description, said composition being simultaneously in contact with a first substrate and a second substrate of said vehicle.

Furthermore, the present invention relates to the use of the composition according to the invention as sealant, in particular as sealing joint.

Finally, the present invention relates to the use of the composition according to the invention, for adhesive bonding and sealing.

Surprisingly, it has been found that the addition of a combination of a rheological agent and a carbon black with a high OAN to a silyl-modified polymer composition makes it possible to significantly improve both the tensile strength and elongation at break properties of the composition.

The composition according to the invention is therefore particularly advantageous for attaching a glass pane (for example a windshield or window) to the bodywork of a vehicle, in particular for replacing the windshield of a vehicle.

### DESCRIPTION OF THE INVENTION

Thus, the invention relates to a composition comprising:
a silyl-modified polymer,
carbon black having an oil absorption number (OAN) of at least 80 ml/100 g, and
a rheological agent.

### Silyl-Modified Polymer

A “silyl-modified polymer” is understood to mean a polymer comprising at least one alkoxysilane group. Preferably, the silyl-modified polymer comprises at least one alkoxysilane group positioned at the end of the polymer.

The silyl-modified polymer is generally in the form of a more or less viscous liquid. Advantageously, the silyl-modified polymer has a viscosity at 23° C. ranging from 10 to 200 Pa·s, preferably from 20 to 175 Pa·s, more preferentially from 30 to 150 Pa·s, even more preferentially from 45 to 125 Pa·s.

The viscosity of the silyl-modified polymer can, for example, be measured according to a Brookfield method at 23° C. and 50% relative humidity (spindle S28).

In the context of the invention, the ranges of values are understood to mean limits included. For example, the range “between 0% and 25%” notably includes the values 0% and 25%.

Advantageously, the silyl-modified polymer comprises at least one, preferably at least two, alkoxysilane groups of formula (I):

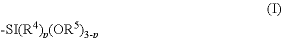

wherein:
R⁴ represents a linear or branched alkyl radical comprising from 1 to 4 carbon atoms, and when p is equal to 2, the R⁴ radicals are identical or different,
R⁵ represents a linear or branched alkyl radical comprising from 1 to 4 carbon atoms, and when p is equal to 0 or 1, the R⁵ radicals are identical or different, it being possible for two OR⁵ groups to be inserted in the same ring, and
p is an integer equal to 0, 1 or 2, preferably equal to 0 or 1.

Preferably, the alkoxysilane groups of the silyl-modified polymer are of formula (I) with:
R⁴ and R⁵ each represent a methyl radical, and
p is equal to 0 or 1.

Advantageously, the silyl-modified polymer has a number-average molar mass of between 500 g/mol and 70000 g/mol, preferentially between 4000 g/mol and 60000 g/mol, more preferentially between 10000 g/mol and 50000 g/mol.

The molar mass of the polymers may be measured by methods well known to those skilled in the art, for example by NMR or by size exclusion chromatography using polystyrene standards.

Advantageously, the silyl-modified polymer is of formula (II), (III) or (IV):

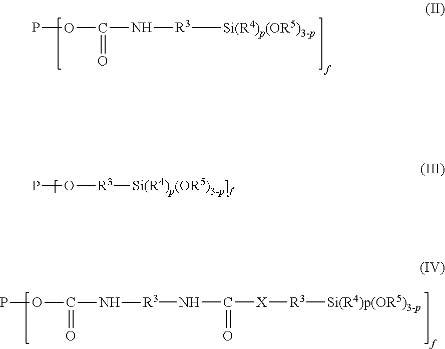

wherein:
R⁴, R⁵ and p have the same meaning as in formula (I) described above,
P represents a saturated or unsaturated polymer radical, with a linear or branched open chain, or comprising one or more optionally aromatic rings, optionally comprising one or more heteroatoms, such as oxygen, nitrogen, sulfur and/or silicon, preferably oxygen and/or nitrogen, and optionally comprising one or more ionic groups,
R¹ represents a saturated or unsaturated divalent hydrocarbon radical comprising from 5 to 15 carbon atoms, with a linear or branched open chain, or comprising one or more optionally aromatic rings,
R³ represents a linear or branched divalent alkylene radical comprising from 1 to 6 carbon atoms, preferably from 1 to 3 carbon atoms,
X represents a divalent radical chosen from —NH—, —NR⁷— or —S—,
R⁷ represents a linear or branched alkyl radical comprising from 1 to 20 carbon atoms and which may also comprise one or more heteroatoms,
f is an integer ranging from 1 to 6, advantageously from 2 to 5, preferentially from 2 to 4, even more preferentially from 2 to 3.

Advantageously, the silyl-modified polymer is of formula (II), (III) or (IV) with P representing a polymer radical chosen from polyethers, polycarbonates, polyesters, polyolefins, polyacrylates, polyether polyurethanes, polyester polyurethanes, polyolefin polyurethanes, polyacrylate polyurethanes, polycarbonate polyurethanes, block polyether/polyester polyurethanes and polysiloxanes, preferably chosen from polyethers, polyurethanes and mixtures thereof, more preferentially from polyethers.

Preferably, the silyl-modified polymer is of formula (II′), (II″), (III′) or (IV′):

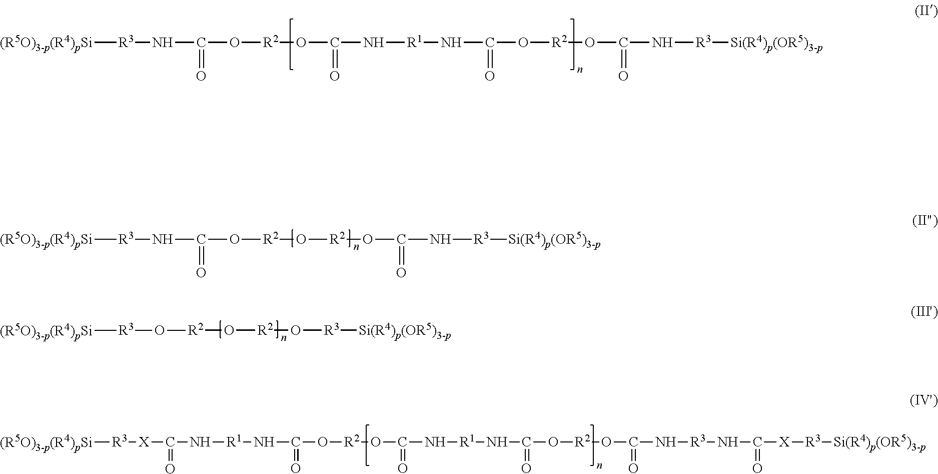

wherein:
R¹, R³, R⁴, R⁵, X, R⁷ and p have the same meaning as in formulae (II), (III) and (IV),
R² represents a linear or branched, saturated or unsaturated divalent hydrocarbon radical optionally comprising one or more heteroatoms, such as oxygen, nitrogen, sulfur, silicon, and optionally comprising one or more ionic groups,
n is an integer, preferably n is such that the number-average molar mass of the silyl-modified polymer is between 500 g/mol and 70000 g/mol, more preferentially between 4000 g/mol and 60000 g/mol, even more preferentially between 10000 g/mol and 50000 g/mol.

In the silyl-modified polymers of formulae (II′), (II″), (III′) and (IV′) defined above, when the R² radical comprises one or more heteroatoms, said heteroatom(s) are not present at the chain end. In other words, the free valencies of the divalent R² radical bonded to the neighboring oxygen atoms of the silyl-modified polymer each originate from a carbon atom. Thus, the main chain of the R² radical is terminated by a carbon atom at each of the two ends, said carbon atom then having a free valency.

According to one embodiment, the silyl-modified polymers are obtained from polyols chosen from polyether polyols, polyester polyols, polycarbonate polyols, polyacrylate polyols, polysiloxane polyols, polyolefin polyols and mixtures thereof, preferably from diols chosen from polyether diols, polyester diols, polycarbonate diols, polyacrylate diols, polysiloxane diols, polyolefin diols and mixtures thereof, more preferentially from polyether diols. In the case of the polymers of formulae (II′), (II″), (III′) and (IV′) described above, such diols can be represented by the formula HO—R²—OH or H—[O—R²], —OH, where R² has the same meaning as in the formulae (II′), (II″), (III′) and (IV′).

In particular, in the silyl-modified polymer of formula (IV′) defined above, the R² radical may be identical or different, that is to say the silyl-modified polymer of formula (IV′) may be a silyl-modified copolyurethane obtained from identical or different HO—R²—OH diols.

According to one embodiment, when the silyl-modified polymer is of formula (II′) or (IV′), the R² radical can be chosen from the following divalent radicals, the formulae of which below show the two free valencies:
derivative of a polypropylene glycol

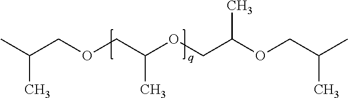

derivative of a polyester diol:

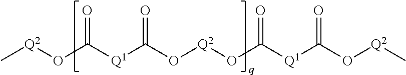

derivative of a polybutadiene diol:

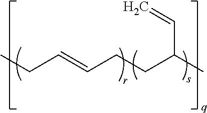

derivative of a polyacrylate diol:

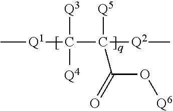

derivative of a polysiloxane diol:

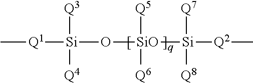

in which:
q represents an integer such that the number-average molar mass of the R² radical ranges from 100 g/mol to 48600 g/mol, preferably from 300 g/mol to 18600 g/mol, more preferably from 500 g/mol to 12600 g/mol,
r and s represent zero or a nonzero integer such that the number-average molar mass of the R² radical ranges from 100 g/mol to 48600 g/mol, preferably from 300 g/mol to 18600 g/mol, more preferably from 500 g/mol to 12600 g/mol, it being understood that the sum r+s is other than zero,
Q¹ represents a saturated or unsaturated, linear or branched aliphatic or aromatic divalent alkylene radical preferably having from 1 to 18 carbon atoms, more preferably from 1 to 8 carbon atoms,
Q² represents a linear or branched divalent alkylene radical preferably having from 2 to 36 carbon atoms, more preferably from 1 to 8 carbon atoms,
Q³, Q⁴, Q⁵, Q⁶, Q⁷ and Q⁸ represent, independently of each other, a hydrogen atom or an alkyl, alkenyl or aromatic radical preferably containing from 1 to 12 carbon atoms, preferably from 2 to 12 carbon atoms, more preferably from 2 to 8 carbon atoms.

According to one particular embodiment, when the silyl-modified polymer is of formula (IV′), the silyl-modified polymer can be obtained from different HO—R²—OH diols, in which one R² radical can be chosen from the divalent radicals above (derivative of a polypropylene glycol, a polyester diol, a polybutadiene diol, a polyacrylate diol, a polysiloxane diol) and wherein one R² radical is the ionic divalent radical of formula:

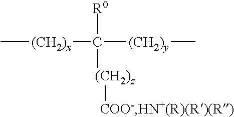

wherein:
x and y, which may be identical or different, are integers ranging from 1 to 8,
z is an integer ranging from 0 to 8,
R⁰ represents a hydrogen atom or an alkyl radical comprising from 1 to 18 carbon atoms, and
R, R′ and R″, which may be identical or different, each represent a saturated, unsaturated or aromatic hydrocarbon radical, optionally comprising a heteroatom chosen from N, O and S; R, R′ and R″ furthermore being such that the tertiary amine of formula N(R)(R′)(R″) is a linear, branched or cyclic amine or polyamine having a number-average molar mass Mn which ranges from 59 to 6000 g/mol and which has a pKa of greater than 8.

According to one embodiment, R¹ is chosen from the following divalent radicals, the formulae of which below show the two free valencies:
a) the divalent radical derived from isophorone diisocyanate (IPDI):

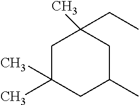

b) the divalent radical derived from dicyclohexylmethane diisocyanate (H12MDI):

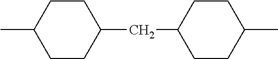

c) the divalent radicals derived from the 2,4- and 2,6-isomers of toluene diisocyanate (TDI):

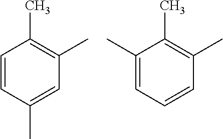

d) the divalent radicals derived from the 4,4′- and 2,4′-isomers of diphenylmethane diisocyanate (MDI):

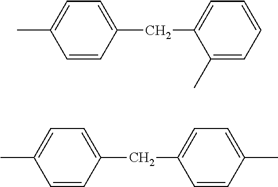

e) the divalent radical derived from hexamethylene diisocyanate (HDI): —(CH₂)₆—
f) the divalent radical derived from m-xylylene diisocyanate (m-XDI):

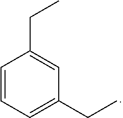

According to a preferred embodiment, the silyl-modified polymer is of formula (II″) or (III′), preferentially (III′), and the R² radical preferably represents a linear or branched divalent alkylene radical comprising from 2 to 4 carbon atoms, more preferentially a linear or branched divalent alkylene radical comprising 3 carbon atoms, even more preferentially an isopropylene radical (of formula —CH₂—CH(CH₃)—).
According to a particularly preferred embodiment, the silyl-modified polymer is a polymer of formula (III′) in which:
R² represents an iso-propylene radical,
R⁴ and R⁵ each represent a methyl radical, and
p is equal to 1.

The polymers of formula (II), (II′) and (II″) can be obtained according to a process described for example in documents EP 2 336 208 and WO 2009/106699. Mention may be made, among the polymers corresponding to the formula (II), of:
Geniosil® STP-E10 (available from Wacker Chemie): polyether of formula (II″) comprising two groups of formula (I) of dimethoxy type (p equal to 1 and R⁴ and R⁵ represent a methyl group) having a number-average molar mass of 8889 g/mol where R³ represents a methyl group;
Geniosil® STP-E30 (available from Wacker Chemie): polyether of formula (II″) comprising two groups of formula (I) of dimethoxy type (p equal to 1 and R⁴ and R⁵ represent a methyl group) having a number-average molar mass of 14493 g/mol where R³ represents a methyl group;
Desmoseal® S XP 2636 (available from Bayer): polyurethane comprising two groups of formula (I) of trimethoxy type (p equal to 0 and R⁵ represents a methyl group) having a number-average molar mass of 15038 g/mol where R³ represents an n-propylene group.

The polymers of formula (III) or (III′) can be obtained by hydrosilylation of polyether diallyl ether according to a process described, for example, in the document EP 1 829 928. Mention may be made, among the polymers corresponding to the formula (III), of:
the polymer MS SAX® 350 (available from Kaneka) corresponding to a polyether comprising two groups of formula (I) of dimethoxy type (p equal to 1 and R⁴ and R⁵ represent a methyl group) having a number-average molar mass ranging from 14000 to 16000 g/mol;
the polymer MS SAX® 260 (available from Kaneka) corresponding to a polyether comprising two groups of formula (I) of dimethoxy type (p equal to 1 and R⁴ and R⁵ represent a methyl group) having a number-average molar mass of 16000 to 18000 g/mol where R³ represents an ethyl group;
the polymer MS S303H (available from Kaneka) corresponding to a polyether comprising two groups of formula (I) of dimethoxy type (p is equal to 1 and R⁴ represents a methyl group) having a number-average molecular weight of from 21000 to 23000 g/mol;
the polymer MS SAX® 725 (available from Kaneka) corresponding to a polyether (R² represents an isopropylene radical) comprising two groups of formula (I) of dimethoxy type (p equal to 1 and R⁴ and R⁵ represent a methyl group) having a number-average molar mass of around 41 kg/mol.

The polymers of formula (IV) or (IV′) can, for example, be obtained by reaction of polyol(s) with one or more diisocyanate(s) followed by a reaction with aminosilanes or mercaptosilanes. A process for preparing polymers of formula (IV) or (IV′) is described for example in document EP 2 583 988. A person skilled in the art will know how to adapt the manufacturing process described in this document in the case of the use of different types of polyols. Mention may be made, among the polymers corresponding to the formula (IV), of:
SPUR+® 1050 MM (available from Momentive): polyurethane comprising two groups of formula (I) of trimethoxy type (p equal to 0 and R⁵ represents a methyl group) having a number-average molar mass of 16393 g/mol where R³ represents an n-propyl group;
SPUR+® Y-19116 (available from Momentive): polyurethane comprising two groups of formula (I) of trimethoxy type (p equal to 0 and R⁵ represents a methyl group) having a number-average molar mass ranging from 15000 to 17000 g/mol where R³ represents an n-propyl group.

The content of silyl-modified polymer in the composition according to the invention may range from 5% to 60% by weight relative to the total weight of the composition, preferentially from 10% to 55% by weight, more preferentially from 20% to 50% by weight, even more preferentially from 30% to 45% by weight, in particular from 35% to 40% by weight.

### Carbon Black

The carbon black in the composition of the invention has an oil absorption number (OAN) of at least 80 ml/100 g.

The OAN of a carbon black corresponds to the volume in ml of dibutyl phthalate (DBP) oil absorbed by 100 g of carbon black.

The OAN can for example measured according to the ASTM D-2414 method and using DBP oil.

Unless otherwise indicated, the standards mentioned throughout the application are those in force on the date of filing of the application.

The carbon black used in the present invention is generally referred to as “structural” carbon black, and differs from the carbon blacks generally used as pigments, in particular owing to its high OAN.

Specifically, the carbon blacks used as pigments are of lower quality and have a lower OAN than the carbon black used in the present invention.

An example of carbon black used as a pigment is PRINTEX® 25 (sold by Orion), which has an OAN of 45 ml/100 g.

Examples of carbon black that can be used in the present invention are ELFTEX® S7100 and ELFTEX® S5100 (sold by CABOT), having an OAN of around 117 and 108 ml/100 g, respectively.

The term “around X” is intended to mean plus or minus 10% of the value of X.

Preferably, the OAN of the carbon black is at least 90 ml/100 g, more preferentially at least 100 ml/100 g, even more preferentially at least 110 ml/100 g.

Advantageously, the content of carbon black in the composition according to the invention is at least 2% by weight relative to the total weight of the composition, preferably from 3% to 20% by weight, more preferentially from 5% to 18% by weight, even more preferentially from 6% to 15% by weight, for example 6%.

### Rheological Agent

The rheological agent makes it possible to adjust the rheological properties of the composition according to the invention.

By way of example, mention may be made of any rheological agent customarily used in the field of sealant compositions.

Advantageously, the rheological agent is one or more thixotropic agents, the thixotropic agents being, for example, solid at 23° C. and/or having a viscosity at 23° C. of greater than 200 mPa·s according to the standard ISO 12058-1, preferably solid at 23° C. A thixotropic agent generally influences the thixotropy of a composition. Thixotropy is the property of certain compositions to become less viscous when a constant force (for example shear at constant stress) is applied and, after the stress has ceased, the viscosity returns to its initial state after an appropriate period of time. The higher the force, the lower the viscosity.

In particular, use is made of one or more rheological agents chosen from:
PVC plastisols, corresponding to a suspension of PVC in a plasticizing agent which is miscible with PVC, obtained in situ by heating to temperatures ranging from 60° C. to 80° C. These plastisols can be those described in particular in the publication Polyurethane Sealants, Robert M. Evans, ISBN 087762-998-6;
fumed silica, such as HDK® N20 sold by Wacker;
urea derivatives resulting from the reaction of an aromatic diisocyanate monomer, such as 4,4′-MDI, with an aliphatic amine, such as butylamine. The preparation of such urea derivatives is particularly described in patent application FR 1 591 172;
waxes derived from castor oil, such as THIXCIN® R available from Elementis,
amide waxes, preferably micronized amide waxes, such as CRAYVALLAC® SLX, CRAYVALLAC® SLW or CRAYVALLAC® SUPER sold by Arkema, or else THIXATROL® AS8053 or THIXATROL® MAX (EC No.: 432-430-3) which are available from Elementis, or else RHEOBYK 7503 sold by BYK.

These rheological agents are thixotropic agents.

The term “waxes derived from castor oil” is understood to mean waxes obtained from castor oil, in particular hydrogenated castor oil. Waxes derived from castor oil are solid at 23° C.

The term “amide waxes” is understood to mean waxes comprising one or more compounds having at least one amide group. In particular, amide waxes can be obtained from fatty acid(s) (for example ricinoleic acid) and (di)amine(s). Amide waxes are solid at 23° C.

Preferably, the rheological agent is an amide wax and/or a wax derived from castor oil, more preferentially an amide wax.

The amide waxes are preferably micronized, that is to say that they have a mean particle size of less than 1 mm. Advantageously, the amide waxes have a mean particle size of less than 500 μm, preferably less than 100 μm, more preferentially less than 10 μm.

The mean particle size advantageously corresponds to the d50 particle size, i.e. the maximum size of 50% of the smallest particles by volume, and can be measured with a laser particle size analyzer, in particular by laser diffraction on a MALVERN apparatus (for example according to the NF ISO 13320 standard).

Rheological agents of amide wax type may be heat activatable, that is to say that a temperature above ambient temperature (23° C.) may be needed in order to activate it (in particular, to activate the rheological properties, notably thixotropic properties, thereof), during the preparation of the composition according to the invention.

The activation temperature depends on the rheological agent.

For example, THIXATROL® AS8053 is generally activated at a temperature between 50° C. and 55° C., and CRAYVALLAC® SLX is generally activated at a temperature between 75° C. and 80° C.

Advantageously, the content of rheological agent in the composition according to the invention ranges from 0.2% to 20% by weight relative to the total weight of the composition, preferably from 1% to 10% by weight, more preferentially from 1% to 5% by weight.

### Adhesion Promoter

The composition according to the invention may also comprise at least one adhesion promoter.

Advantageously, the adhesion promoter is chosen from amino-, mercapto-and epoxy-alkoxysilanes, preferably chosen from aminoalkoxysilanes, more preferentially from aminotrialkoxysilanes, even more preferentially from aminotrimethoxysilanes.

As an example of an epoxyalkoxysilane, mention may be made of (3-glycidyloxypropyl) trimethoxysilane (also known as GLYMO).

Advantageously, the aminotrimethoxysilanes are formed by the group consisting of 4-amino-3,3-dimethylbutyltrimethoxysilane (for example Silquest A-Link 600 sold by Momentive), (3-aminopropyl)trimethoxysilane (for example Dynasylan® AMMO sold by Evonik) and N-(2-aminoethyl)-3-aminopropyltrimethoxysilane (for example Dynasylan® DAMO or DAMO-T sold by Evonik). Preferably, the aminotrimethoxysilanes are formed by the group consisting of 4-amino-3,3-dimethylbutyltrimethoxysilane and (3-aminopropyl)trimethoxysilane.

Advantageously, the composition according to the invention comprises at least one adhesion promoter.

According to a preferred embodiment, the at least one adhesion promoter is a mixture of at least two adhesion promoters, preferably of two adhesion promoters.

According to this preferred embodiment, the adhesion promoters are chosen from aminoalkoxysilanes, preferably from aminotrialkoxysilanes, more preferentially from aminotrimethoxysilanes. Preferably, the adhesion promoter is a mixture of two adhesion promoters chosen from 4-amino-3,3-dimethylbutyltrimethoxysilane, (3-aminopropyl)trimethoxysilane and n-butyl-3-aminopropyltrimethoxysilane. More preferentially, the adhesion mixture promoter is a of 4-amino-3.3-dimethylbutyltrimethoxysilane and (3-aminopropyl)trimethoxysilane.

According to a preferred embodiment in which the adhesion promoter is a mixture of two adhesion promoters, the (1^{st} adhesion promoter)/(2^{nd} adhesion promoter) weight ratio is advantageously between 0.25 and 4, preferably between 0.5 and 2, more preferentially between 0.7 and 1.5, for example equal to 1.

The content of adhesion promoter(s) in the composition according to the invention may range from 0.2% to 5% by weight relative to the total weight of the composition, preferably from 0.5% to 3% by weight, more preferentially from 1.0% to 2.0% by weight.

### Filler

Advantageously, the composition according to the invention further comprises a filler.

Preferably, the filler is chosen from mineral fillers, organic fillers and mixtures thereof, more preferentially from mineral fillers.

Advantageously, the mineral fillers are formed by the group consisting of clay, quartz, hollow mineral microspheres and carbonate fillers.

Among the hollow mineral microspheres, mention may be made of hollow glass microspheres, and more particularly those made of sodium calcium borosilicate or of aluminosilicate.

Preferably, the mineral fillers are formed by the group consisting of carbonate fillers.

According to a preferred embodiment, the composition according to the invention further comprises a carbonate filler, advantageously the carbonate filler is chosen from alkali or alkaline-earth metal carbonates and mixtures thereof, preferentially the carbonate filler comprises calcium carbonate, more preferentially, the carbonate filler is chalk or calcium carbonate coated with fatty acids, even more preferentially precipitated calcium carbonate coated with fatty acids.

When calcium carbonate is coated with fatty acids, this makes it possible to impart total or partial hydrophobicity to the calcium carbonate particles. Moreover, the coating of fatty acids acts as a hydrophobic coating can make it possible to prevent the calcium carbonate from absorbing the constituents of the composition and from rendering them ineffective. The hydrophobic coating of the calcium carbonate can represent from 0.1% to 3.5% by weight, relative to the total weight of calcium carbonate.

Preferably, the fatty acids coating the calcium carbonate comprise or consist of more than 50% by weight of stearic acid relative to the total weight of the fatty acids.

Examples of non-precipitated calcium carbonate coated with fatty acids that may be mentioned include OMYACARB 2T-AV or OMYA BLH (sold by OMYA), or CALATEM C16T (sold by Provençale).

Examples of precipitated calcium carbonate coated with fatty acids that may be mentioned include HAKUENKA® CCR-S10 (sold by OMYA) or CALOFORT® (sold by Specialty Minerals).

Advantageously, the organic fillers are formed by the group consisting of polyvinyl chloride (PVC), polyolefins, rubber, ethylene/vinyl acetate (EVA), expandable or non-expandable hollow thermoplastic polymer microspheres (such as hollow vinylidene chloride/acrylonitrile microspheres) and aramid fibers (such as Kevlar®), preferably PVC.

Advantageously, the mean particle size of the filler is between 10 nm and 400 μm, preferably between 20 nm and 100 μm, more preferentially between 30 nm and 1 μm, even more preferentially between 40 nm and 300 nm.

The mean particle size advantageously corresponds to the d50 particle size, i.e. the maximum size of 50% of the smallest particles by volume, and can be measured with a laser particle size analyzer, in particular by laser diffraction on a MALVERN apparatus (for example according to the NF ISO 13320 standard).

Advantageously, the filler content ranges from 10% to 80% by weight relative to the total weight of the composition, preferably from 20% to 60% by weight, more preferentially from 30% to 50% by weight, even more preferentially from 35% to 40% by weight.

### Crosslinking Catalyst

The composition according to the invention may also comprise a crosslinking catalyst.

The catalyst can be any catalyst known to a person skilled in the art for the condensation of silanol. Examples of such catalysts that may be mentioned include:
organic derivatives of titanium such as titanium acetylacetonate (for example TYZOR® AA75 sold by Dorf Ketal),
aluminum, such as aluminum chelate (for example K-KAT® 5218 sold by King Industries),
amines, such as 1,8-diazabicyclo [5.4.0] undec-7-ene (DBU) or 1,5-diazabicyclo[4.3.0] non-5-ene (DBN), 2,2′-dimorpholinodiethyl ether (DMDEE) or 1,4-diazabicylo[2.2.2] octane (DABCO),
catalysts based on zinc carboxylate and DBU (for example K-KAT® 670 sold by King Industries),
tin-based catalysts such as the compounds derived from dioctyltin or dibutyltin; in particular dioctyltin oxide, dioctyltin diacetate, dioctyltin dilaurate, dioctyltin dicarboxylate, dibutyltin diacetylacetonate (DBTDAA), dibutyltin dilaurate (DBTDL), dibutyltin diacetate or dibutyltin oxide, preferably dioctyltin oxide or dibutyltin oxide. Mention may be made, for example, of NEOSTANN® S-1 (sold by KANEKA), or TIB KAT® 425 or TIB KAT® 423 (sold by TIB CHEMICALS),
guanidine derivatives such as 1-(o-tolyl)biguanide (CAS No.: 93-69-6), for example Rhenocure 1000 C (sold by RheinChemie Additives).

Preferably, the crosslinking catalyst is a tin-based catalyst, preferably chosen from compounds derived from dioctyltin and dibutyltin, more preferentially from dioctyltin oxide or dibutyltin oxide.

The content of crosslinking catalyst in the composition according to the invention may range from 0.01% to 5% by weight relative to the total weight of the composition, preferably from 0.02% to 2% by weight, more preferentially from 0.05% to 1% by weight, even more preferentially from 0.1% to 0.8% by weight.

The composition according to the invention may also further comprise a crosslinking cocatalyst. Advantageously, the crosslinking cocatalyst is an organic polyester derived from silicic acid, that is to say an organic compound derived from silicic acid comprising at least two alkoxysilane functions. Mention may be made, for example, of tetraethoxysilane (for example WACKER® TES 28 or TES 40 WN) or 1,2-bis(triethoxysilyl)ethane (for example Dynasylan® BTSE).

The content of crosslinking cocatalyst in the composition according to the invention may range from 0.01% to 5% by weight relative to the total weight of the composition, preferably from 0.05% to 2% by weight, more preferentially from 0.1% to 1% by weight.

### Other Additives

The composition according to the invention may further comprise at least one additive chosen from plasticizers, moisture absorbers, solvents, UV stabilizers and mixtures thereof.

Advantageously, the composition according to the invention comprises a mixture of additives chosen from plasticizers, moisture absorbers, solvents and UV stabilizers (or antioxidants).

The total content of additives in the composition according to the invention may range from 0.5% to 30% by weight relative to the total weight of the composition, preferably from 5% to 25% by weight, more preferentially from 10% to 20% by weight.

Advantageously, the composition according to the invention comprises a plasticizer. A plasticizer is different from a rheological agent because the properties of a composition comprising a plasticizer will be identical under the application of stress (such as shear) or in the absence of stress. On the other hand, the properties of a composition comprising a rheological agent will be different if a stress is applied. A plasticizer can be used to adjust the viscosity (like a solvent).

The plasticizer can be any plasticizer commonly used in the field of sealant compositions.

Preferably, the plasticizer is chosen from:
diisodecyl phthalate (for example PALATINOL® DIDP sold by BASF),
diisononyl phthalate (DINP) (for example PALATINOL® N sold by BASF),
an alkylsulfonic acid ester of phenol (for example MESAMOLL® sold by LANXESS),
1,2-cyclohexanedicarboxylic acid diisononyl ester (for example HEXAMOLL DINCH® sold by BASF), and
pentaerythritol tetravalerate (for example PEVALEN™ sold by PERSTORP).

More preferentially, the plasticizer is 1,2-cyclohexanedicarboxylic acid diisononyl ester.

Advantageously, the plasticizer content ranges from 2% to 25% by weight relative to the total weight of the composition, preferably from 5% to 20% by weight, more preferentially from 7% to 15% by weight.

The composition according to the invention may also comprise from 0% to 5% by weight of a solvent relative to the total weight of the composition, preferably a solvent that is volatile at ambient temperature (temperature of about 23° C.). The volatile solvent may, for example, be chosen from alcohols which are volatile at ambient temperature, such as ethanol or isopropanol. The volatile solvent makes it possible, for example, to reduce the viscosity of the composition and make the composition easier to apply. The volatile character of the solvent makes it possible for the joint, obtained after curing the composition, to no longer contain solvent. Thus, the solvent has, for example, no negative influence on the hardness of the joint.

Advantageously, the composition according to the invention comprises up to 3.5% by weight of a moisture absorber, relative to the total weight of the composition, which may be chosen from vinyltrimethoxysilane (for example Dynasylan@ VTMO sold by Evonik), propyltrimethoxysilane (for example Dynasylan@ PTMO sold by Evonik), vinyltriethoxysilane (VTEO), alkoxyarylsilanes (for example GENIOSIL® XL 70 sold by Wacker), p-toluenesulfonyl isocyanate (PTSI) and calcium oxide.

Preferably, the moisture absorber is chosen from vinyltrimethoxysilane, vinyltriethoxysilane and alkoxyarylsilanes, more preferentially vinyltrimethoxysilane.

Advantageously, the composition according to the invention comprises up to 1% by weight of one or more UV stabilizers (or antioxidants) relative to the total weight of the composition. The UV stabilizers are typically introduced to protect the composition from degradation resulting from a reaction with oxygen which is liable to be formed by the action of heat or light. These compounds may include antioxidants capable of trapping free radicals.

Advantageously, the UV stabilizer(s) (or antioxidants) are chosen from hindered benzotriazoles, benzophenones, phenols and amines such as bis(1-octyloxy-2,2,6,6-tetramethyl-4-piperidyl)sebacate, bis(2,2,6,6-tetramethyl-4-piperidyl)sebacate, is (1,2,2,6,6-pentamethyl-4-piperidyl)sebacate (CAS No.: 41556-26-7), methyl 1,2,2,6,6-pentamethyl-4-piperidyl sebacate (CAS No.: 82919-37-7), octadecyl 3-(3,5-di-tert-butyl-4-hydroxyphenyl)propionate, 4,4′-bis(α,α-dimethylbenzyl)diphenylamine, and mixtures thereof. Mention may be made, for example, of the products IRGANOX 1076, TINUVIN® 292, TINUVING 765 or TINUVIN® 770 DF sold by BASF, RIASORB UV-123 sold by RIANLON, AddWorks® IBC 760 sold by Clariant and OKABEST CLX 50 sold by OKA.

Preferably, the UV stabilizer(s) (or antioxidants) are chosen from hindered phenols and amines such as bis(1-octyloxy-2,2,6,6-tetramethyl-4-piperidyl)sebacate, bis(2,2,6,6-tetramethyl-4-piperidyl)sebacate, octadecyl 3-(3,5-di-tert-butyl-4-hydroxyphenyl)propionate, 4,4′-bis(α,α-dimethylbenzyl)diphenylamine, and mixtures thereof.

According to one embodiment, the UV stabilizers (or antioxidants) are a mixture of bis(1-octyloxy-2,2,6,6-tetramethyl-4-piperidyl)sebacate, bis(2,2,6,6-tetramethyl-4-piperidyl)sebacate, octadecyl 3-(3,5-di-tert-butyl-4-hydroxyphenyl)propionate and 4,4′-bis(α,α-dimethylbenzyl)diphenylamine.

### Other Characteristics of the Composition According to the Invention

According to one embodiment, the composition according to the invention comprises:
from 5% to 60% by weight of silyl-modified polymer, relative to the total weight of the composition,
at least 3% by weight of carbon black having an OAN of at least 80 ml/100 g, relative to the total weight of the composition,
from 0.2% to 20% by weight of rheological agent (advantageously thixotropic agent), relative to the total weight of the composition,
from 0.2% to 5% by weight of adhesion promoter(s), relative to the total weight of the composition,
from 10% to 80% by weight of filler, relative to the total weight of the composition,
from 0.01% to 5% by weight of crosslinking catalyst, relative to the total weight of the composition,
optionally from 0.01% to 5% by weight of crosslinking cocatalyst relative to the total weight of the composition, and
from 0.5% to 30% by weight of one or more additives chosen from plasticizers, moisture absorbers, solvents and UV stabilizers, relative to the total weight of the composition.

Preferably, the composition according to the invention consists essentially of the ingredients mentioned above. The term “consists essentially” is understood to mean that the composition according to the invention comprises less than 5% by weight of ingredients other than the abovementioned ingredients, relative to the total weight of the composition, preferably less than 2% by weight, even more preferentially less than 1% by weight.

The ingredients of this embodiment and the particular contents thereof are as described above, including the embodiments.

According to one particular embodiment, the composition according to the invention comprises:
from 35% to 40% by weight of silyl-modified polymer, relative to the total weight of the composition, the silyl-modified polymer preferably being a polymer of formula (III′),
from 6% to 15% by weight of carbon black, relative to the total weight of the composition, said carbon black having an OAN of at least 80 ml/100 g, preferably of at least 110 ml/100 g,
from 1% to 5% by weight of rheological agent, relative to the total weight of the composition, the rheological agent being an amide wax,
from 1.0% to 2.0% by weight of adhesion promoters, relative to the total weight of the composition, the adhesion promoters being chosen from aminotrimethoxysilanes,
from 35% to 40% by weight of filler, relative to the total weight of the composition, the filler being precipitated calcium carbonate coated with fatty acids,
from 0.1% to 0.8% by weight of crosslinking catalyst, relative to the total weight of the composition, the crosslinking catalyst being a tin-based catalyst,
optionally from 0.1% to 1% by weight of crosslinking cocatalyst relative to the total weight of the composition, the crosslinking cocatalyst being an organic polyester derived from silicic acid, and
from 10% to 20% by weight of one or more additives chosen from plasticizers, moisture absorbers, solvents and UV stabilizers, relative to the total weight of the composition.

Preferably, the composition according to the invention consists essentially of the ingredients mentioned above.

The ingredients of this embodiment and the particular contents thereof are as described above, including the embodiments.

Advantageously, the composition according to the invention has a tensile strength (often abbreviated to TS) of greater than or equal to 3.5 MPa, preferably greater than or equal to 4 MPa, more preferentially greater than or equal to 4.2 MPa, even more preferentially greater than or equal to 4.4 MPa.

Advantageously, the composition according to the invention has an elongation at break of greater than 210%, preferably greater than or equal to 300%, more preferentially greater than or equal to 400%, even more preferentially greater than or equal to 500%.

According to a preferred embodiment, the composition according to the invention has a tensile strength of greater than or equal to 3.5 MPa and an elongation at break of greater than 210%, preferably, a tensile strength of greater than or equal to 4 MPa and an elongation at break of greater than or equal to 300%, more preferentially a tensile strength of greater than or equal to 4.2 MPa and an elongation at break of greater than or equal to 400%, even more preferentially a tensile strength of greater than or equal to 4.4 MPa and an elongation at break of greater than or equal to 500%.

A person skilled in the art knows how to determine the tensile strength and elongation at break of a composition. For example, the tensile strength and elongation at break can be measured in accordance with the standard ISO 37 (December 2005), preferably at a constant speed equal to 500 mm/min.

In particular, the tensile strength and elongation at break can be measured as described in example 1 below.

### Preparation of the Composition According to the Invention

The composition according to the invention can be prepared by simply mixing its ingredients.

According to a preferred embodiment, the composition according to the invention is prepared according to the following process:
1) the silyl-modified polymer is mixed, in a suitable container, with any liquid additives such as plasticizer, solvent, moisture absorber and UV stabilizer (or antioxidant), preferably at a temperature of between 18° C. and 28° C. and at atmospheric pressure, then
2) carbon black having an OAN of at least 80 ml/100 g, and any other solid ingredients such as the rheological agent, the filler and the solid additives such as a UV stabilizer (or antioxidant) are dispersed in the preceding liquid mixture, for the time required to obtain a homogeneous mixture, then
3) the rest of any other liquid ingredients, such as adhesion promoter and catalyst, are added and the medium is homogenized.

Preferably, step 2) is carried out at a pressure below atmospheric pressure, more preferentially at a pressure of less than 50 kPa, even more preferentially at a pressure of less than 20 kPa.

Preferably, step 2) is carried out at a temperature above 30° C., more preferentially above 40° C. When the composition according to the invention comprises a heat-activatable rheological agent, the mixing of the solid ingredients is advantageously carried out at a temperature at which the rheological agent is activated.

Preferably, step 3) is carried out at a pressure and a temperature approximately equal to those used in step 2).

An example of preparing the composition according to the invention is described in example 2.

### Other Subjects of the Present Invention

Another subject of the present invention is a process for assembling two substrates by adhesive bonding, comprising:
the coating, onto at least one of the two substrates to be assembled, of the composition according to the invention, as defined previously; then
actually bringing the two substrates into contact.

The substrates involved are very varied, and are preferably chosen from concrete, a metal such as aluminum and/or steel and glass.

According to a preferred embodiment, one of the substrates is steel (for example a portion of the bodywork of a vehicle) and the other substrate is glass (for example a glass pane such as a windshield or window).

The present invention also relates to an article capable of being obtained according to the assembly process as defined above, preferably a vehicle.

The present invention also relates to a vehicle comprising a composition as defined in the present description, said composition being simultaneously in contact with a first substrate and a second substrate of said vehicle, preferably in contact with a portion of the bodywork of a vehicle and a glass pane such as a windshield.

Furthermore, the present invention relates to the use of the composition according to the invention as sealant, in particular as sealing joint.

Finally, the present invention relates to the use of the composition according to the invention, for adhesive bonding and sealing, in particular in the fields of building construction, transport, for example, road, maritime, rail, or aerospace transport, and shipbuilding, preferably in the field of road, maritime, rail or aerospace transport, in particular for attaching a glass pane (for example a windshield or window) to the bodywork of a vehicle, preferably for replacing the windshield of a vehicle.

All the embodiments described above may be combined with each other. In particular, the various abovementioned ingredients of the composition, and in particular the preferred embodiments of the composition, can be combined with each other.

The examples below are given purely by way of illustration of the invention and should not be interpreted as limiting the scope thereof.

### EXAMPLES

### Example 1: Ingredients and Measurement Methods

### Ingredients Used

The following ingredients were used:
MS POLYMER™ S303H sold by KANEKA: dimethoxysilane-terminated poly (propylene oxide) with a number-average molar mass of 21 to 23 kg/mol, and a viscosity of 12.5 Pa·s;
MS POLYMER™ SAX 725 sold by KANEKA: dimethoxysilane-terminated poly (propylene oxide) with a weight-average molar mass Mw of about 51 kg/mol and a number-average molar mass of about 41 kg/mol, and a viscosity of 87 Pa·s;
DYNASYLAN@ VTMO sold by Evonik: vinyltrimethoxysilane (CAS No.: 2768 Feb. 7), moisture absorber;
DYNASYLANG AMMO sold by Evonik: (3-aminopropyl)trimethoxysilane (CAS No.: 13822-56-5), adhesion promoter;
CALOFORT® SV14 sold by Specialty Minerals: precipitated calcium carbonate coated with fatty acids, having a mean particle size of 70 nm;
OMYACARB 2T-AV sold by OMYA: calcium carbonate (also known as GCC for ground calcium carbonate) having a d50 particle size of 2.7 μm and a moisture content of less than or equal to 0.2% relative to the total weight of OMYACARB 2T-AV;
HAKUENKA® CCR-S10 sold by OMYA: precipitated calcium carbonate coated with fatty acids, having a mean particle size of 80 nm;
RIASORB UV-123 sold by RIANLON: bis(1-octyloxy-2,2,6,6-tetramethyl-4-piperidyl)sebacate (CAS No.: 129757-67-1), hindered amine light stabilizer (HALS);
TINUVIN 770 DF sold by BASF: bis(2,2,6,6-tetramethyl-4-piperidyl)sebacate (CAS No.: 52829 Jul. 9), hindered amine light stabilizer (HALS);
PRINTEX® 25 sold by Orion: carbon black having an OAN of 45 ml/100 g measured according to the ASTM D-2414 method;
ELFTEX® S5100 sold by CABOT: carbon black having an OAN of 108 ml/100 g measured according to the ASTM D-2414 method;
ELFTEX® S7100 sold by CABOT: carbon black having an OAN of 117±6 ml/100 g measured according to the ASTM D-2414 method;
SILQUEST A-link 600 sold by MOMENTIVE: 4-amino-3.3-dimethylbutyltrimethoxysilane (CAS No: 157923-74-5), non-yellowing adhesion promoter;
NEOSTANN S-1 sold by KANEKA: silicic acid (H₄SiO₄), tetraethyl ester, reaction products with bis(acetyloxy)dibutylstannane (CAS No.: 93925-43-0), crosslinking catalyst;
TIB KAT 425 sold by TIB CHEMICALS: TIB KAT 232 (dioctyltin oxide)/silane mixture, crosslinking catalyst;
THIXATROL® AS 8053 sold by Elementis: micronized amide wax rheological agent having a mean diameter of less than 5 μm;
CRAYVALLAC® SLX sold by Arkema: micronized amide wax rheological agent (particle size less than 5 μm);
Hexamoll® DINCH sold by BASF: 1,2-cyclohexanedicarboxylic acid diisononyl ester, plasticizer.

### Measurement Methods

Tensile strength, elongation at break, modulus of elasticity and modulus at 100% were measured in accordance with the standard ISO 37 (December 2005) at a constant speed equal to 500 mm/min.

In particular, the following conditions were applied:

A standard test specimen in the shape of a type 1 dumbbell, as illustrated in international standard ISO 37 (December 2005), is used. The narrow part of the dumbbell used has a length of 33 mm, a width of 6 mm and a thickness of 2 mm.

To prepare the dumbbell, the composition to be tested is applied in a Teflon mold, and the composition is left to crosslink for 14 days under standard conditions (23° C. and 50% relative humidity).

The principle of the measurement consists in stretching a standard test specimen in a tensile testing machine, the movable jaw of which is moved at a constant speed equal to 500 mm/minute, and in recording:
the elongation at break (expressed in %) is the elongation of the test specimen corresponding to the stretching observed at the time of breaking,
the modulus at 100% (in MPa) is the tensile stress corresponding to an elongation of 100% of the test specimen,
the modulus of elasticity (expressed in MPa) is the slope of the tangent at the origin of the curve plotting the tensile stress as a function of the elongation of the test specimen, and
the tensile strength (in MPa) is the tensile stress at which the test specimen breaks.

The measurement is repeated for 5 test specimens, and the corresponding mean of the results obtained is calculated.

The shear strength was measured according to the following method:

Two rectangular aluminum plates with dimensions of: 100 mm×25 mm×2 mm are used. After cleaning the two plates with acetone, a rectangular adhesive bonding area with dimensions of 12.5 mm×25 mm is defined, using adhesive tape, at the end of each plate.

On the adhesive bonding area of a 1^{st} substrate plate thus created, the silyl-modified polymer composition is applied, in an amount corresponding to a thickness of 2 mm. Next, superimposed on the area thus coated is the adhesive bonding area of the 2^{nd} substrate plate, so as to obtain an assembly in which the free ends of the 2 substrate plates are aligned on either side of the two areas joined by the sealant.

The specimen assembly obtained is held by clips for 14 days in a room with a controlled atmosphere at 23° C. and 50% relative humidity, for crosslinking of the composition.

The two free ends of the specimen are pulled by means of a tensile testing machine at a constant speed equal to 50 mm/minute, until the assembly breaks, for which the applied stress is recorded.

The measurement is repeated for 3 assembly specimens, and the average of the shear stresses at break (referred to as shear strength) obtained is calculated.

It is also noted whether the failure is of cohesive type (failure within the composition) or adhesive type (failure at the composition/plate interface).

### Example 2: Effect of Incorporating Carbon Black as a Function of its OAN

Comparative composition 1a is prepared by mixing the ingredients in the proportions indicated in table 1 below, in a stirred reactor, in several steps according to the process described below.

The ingredients of step 1 are mixed at ambient temperature (about 23° C.), at atmospheric pressure and at low stirring speed (sufficient for homogenization).

Next, the ingredients of step 2 are added to the reactor used for step 1, and mixed first at atmospheric pressure and at high stirring speed (so as to shear and mix the solids), then the reactor is placed under vacuum (16 kPa), the temperature is increased to 75-80° C. and mixing is carried out for 10 to 30 min.

Finally, the ingredients of step 3 are added under vacuum and the mixing is carried out at a low stirring speed (sufficient for homogenization).

TABLE 1

| | | % by weight relative to the total |
|---|---|---|
| Step | Ingredient | weight of the composition |
| 1 | MS POLYMER S303H | 37 |
| | DYNASYLAN ® VTMO | 2.7 |
| | RIASORB123 | 0.4 |
| 2 | TINUVIN 770 DF | 0.2 |
| | CRAYVALLAC ® SLX | 3.5 |
| | CALOFORT SV14 | 45.5 |
| | OMYACARB 2T-AV | 9.4 |
| 3 | DYNASYLAN ® AMMO | 1 |
| | NEOSTANN S-1 | 0.3 |

Compositions 1b to le are prepared according to the same process as comparative composition 1a and have the same composition, except that:
2% by weight of CALOFORT SV14 are replaced by 2% by weight of PRINTEX 25, relative to the total weight of the composition, for comparative composition 1b;
5% by weight of CALOFORT SV14 are replaced by 5% by weight of PRINTEX 25, relative to the total weight of the composition, for comparative composition 1c;
2% by weight of CALOFORT SV14 are replaced by 2% by weight of ELFTEX S5100, relative to the total weight of the composition, for composition 1d according to the invention;
5% by weight of CALOFORT SV14 are replaced by 5% by weight of ELFTEX S5100, relative to the total weight of the composition, for composition 1e according to the invention.

For example, comparative composition 1b has the same composition as 1a, except that it comprises 43.5% by weight of CALOFORT SV14 and 2% by weight of PRINTEX 25.

Carbon black (PRINTEX 25 or ELFTEX S5100) is also added during step 2 of the process.

The mechanical properties of compositions nos. 1 to 4 (measured in accordance with example 1) are summarized in table 2 below.

TABLE 2

| | 1a | 1b | 1c | | |
|---|---|---|---|---|---|
| | compar- | compar- | compar- | 1d | 1e |
| Composition | ative | ative | ative | invention | invention |
| Modulus at | 2.3 | 2.5 | 2.6 | 2.9 | 3.2 |
| 100% (MPa) | | | | | |
| Tensile | 2.9 | 3 | 3.1 | 3.5 | 4 |
| strength (MPa) | | | | | |
| Elongation at | 180 | 200 | 200 | 230 | 220 |
| break (%) | | | | | |

Comparing the results obtained for compositions 1a and 1b makes it possible to conclude that incorporating PRINTEX 25 does not make it possible to significantly increase the tensile strength of the composition, and enables a slight improvement in the elongation at break (increase of 11%).

Moreover, when a larger amount of PRINTEX 25 is incorporated, this does not make it possible to significantly increase the tensile strength of the composition, and has no influence on its elongation at break (comparing the results obtained for compositions 1b and 1c).

On the other hand, the tensile strength of composition 1d (2% ELFTEX S5100) is 21% higher than that of composition 1a and its elongation at break has been improved by 28%, while the tensile strength of composition 1e (5% ELFTEX S5100) is 38% higher than that of composition 1a and its elongation at break has been improved by 22%.

Thus, the incorporation of ELFTEX S5100 (carbon black having an OAN of 108 ml/100 g) into a silyl-modified polymer composition significantly improves both the tensile strength and the elongation at break of the composition, this effect not being obtained with the incorporation of PRINTEX 25 (carbon black having an OAN of 45 ml/100 g).

### Example 3: Comparative Composition 2a Not Comprising Any Rheological Agent

The various ingredients of comparative composition 2a are mixed in the proportions indicated in table 3 below, in a stirred reactor, in several steps according to the process described below.

The ingredients of step 1 are mixed at ambient temperature (about 23° C.), at atmospheric pressure and at low stirring speed (sufficient for homogenization).

Next, the ingredients of step 2 are added to the reactor used for step 1, and mixed first at atmospheric pressure and at high stirring speed (so as to shear and mix the solids), then the reactor is placed under vacuum (16 kPa), the temperature is increased to 75-80° C. and mixing is carried out for 10 to 30 min.

Finally, the ingredients of step 3 are added under vacuum and the mixing is carried out at a low stirring speed (sufficient for homogenization).

TABLE 3

| | | % by weight relative to |
|---|---|---|
| | | the total weight of the |
| Step | Ingredient | composition |
| 1 | MS POLYMER ™ SAX 725 | 43.53 |
| | DYNASYLAN ® VTMO | 3.00 |
| | RIASORB UV-123 | 0.40 |
| 2 | HAKUENKA ® CCR-S10 | 45.32 |
| | TINUVIN 770 DF | 0.20 |
| | ELFTEX ® S7100 | 6.00 |
| 3 | DYNASYLAN ® AMMO | 0.70 |
| | SILQUEST A-LINK 600 | 0.70 |
| | TIB KAT 425 | 0.15 |

### Example 4: comparative composition 2b not comprising any rheological agent

Comparative composition 2b is similar to comparative composition 2a, except that a plasticizer has been added (Hexamoll® DINCH).

The various ingredients of comparative composition 2b are mixed in the proportions indicated in table 4 below, in a stirred reactor, in several steps according to the process described in example 3.

TABLE 4

| | | % by weight relative to |
|---|---|---|
| | | the total weight of the |
| Step | Ingredient | composition |
| 1 | MS POLYMER ™ SAX 725 | 40.43 |
| | DYNASYLAN ® VTMO | 3.00 |
| | RIASORB UV-123 | 0.40 |
| | Hexamoll ® DINCH | 10.00 |
| 2 | HAKUENKA ® CCR-S10 | 38.32 |
| | TINUVIN 770 DF | 0.20 |
| | ELFTEX ® S7100 | 6.00 |
| 3 | DYNASYLAN ® AMMO | 0.70 |
| | SILQUEST A-LINK 600 | 0.70 |
| | TIB KAT 425 | 0.25 |

### Example 5: Composition 2c According to the Invention

Composition 2c according to the invention is similar to comparative composition 2b, except that a rheological agent has been added (THIXATROL® AS 8053).

The various ingredients of composition 2c are mixed in the proportions indicated in table 5 below, in a stirred reactor, in several steps, according to the process described in example 3 except that the temperature in step 2 is increased to 50-55° C. (corresponding to the activation temperature of THIXATROL® AS 8053) instead of 75-80° C.

TABLE 5

| | | % by weight relative to |
|---|---|---|
| | | the total weight of the |
| Step | Ingredient | composition |
| 1 | MS POLYMER ™ SAX 725 | 38.43 |
| | DYNASYLAN ® VTMO | 3.00 |
| | RIASORB UV-123 | 0.40 |
| | Hexamoll ® DINCH | 10.00 |
| 2 | HAKUENKA ® CCR-S10 | 38.32 |
| | TINUVIN 770 DF | 0.20 |
| | THIXATROL ® AS 8053 | 2.00 |
| | ELFTEX ® S7100 | 6.00 |
| 3 | DYNASYLAN ® AMMO | 0.70 |
| | SILQUEST A-LINK 600 | 0.70 |
| | TIB KAT 425 | 0.25 |

### Example 6: Composition 2d According to the Invention

Composition 2d is similar to composition 2c, except that another rheological agent was used (CRAYVALLAC® SLX).

The various ingredients of composition 2d are mixed in the proportions indicated in table 6 below, in a stirred reactor, in several steps according to the process described in example 3.

TABLE 6

| | | % by weight relative to |
|---|---|---|
| | | the total weight of the |
| Step | Ingredient | composition |
| 1 | MS POLYMER ™ SAX 725 | 38.43 |
| | DYNASYLAN ® VTMO | 3.00 |
| | RIASORB UV-123 | 0.40 |
| | Hexamoll ® DINCH | 10.00 |
| 2 | HAKUENKA ® CCR-S10 | 38.32 |
| | TINUVIN 770 DF | 0.20 |
| | CRAYVALLAC ® SLX | 2.00 |
| | ELFTEX ® S7100 | 6.00 |
| 3 | DYNASYLAN ® AMMO | 0.70 |
| | SILQUEST A-LINK 600 | 0.70 |
| | TIB KAT 425 | 0.25 |

### Example 7: Mechanical Properties of Compositions 2a to 2d

The mechanical properties of compositions 2a to 2d (measured in accordance with example 1) are summarized in table 7 below.

TABLE 7

| | 2a | 2b | 2c | 2d |
|---|---|---|---|---|
| Composition | comparative | comparative | invention | invention |
| Modulus of | 4.79 | 2.86 | 3.06 | 4.3 |
| elasticity (MPa) | | | | |
| Modulus at 100% | 2.70 | 1.55 | 1.61 | 1.83 |
| (MPa) | | | | |
| Elongation at | 447 | 555 | 680 | 691 |
| break (%) | | | | |
| Tensile strength | 5.53 | 4.56 | 4.93 | 5.04 |
| (MPa) | | | | |
| Shear strength | 2.1 | 3.81 | 3.6 | 3.32 |
| (MPa) | | | | |
| Failure pattern | 90% adhesive | 100% | 100% | 100% |
| | 10% cohesive | cohesive | cohesive | cohesive |

The addition of a rheological agent to compositions 2c and 2d according to the invention makes it possible to significantly improve both the elongation at break and the tensile strength of the compositions.

In fact, in comparison with the comparative composition 2b which does not comprise any rheological agent, the tensile strength of composition 2c (THIXATROL® AS 8053) is 8% higher than that of composition 2b and its elongation at break has been improved by 23%, while the tensile strength of composition 2d (CRAYVALLAC® SLX) is 11% higher than that of composition 2b and its elongation at break has been improved by 25%.

Compositions 2c and 2d according to the invention also have the advantage of exhibiting a 100% cohesive failure pattern.

1-14. (canceled)

15. A composition comprising:
a silyl-modified polymer,
carbon black having an oil absorption number (OAN) of at least 80 ml/100 g, and
a rheological agent.

16. The composition as claimed in claim 15, wherein the silyl-modified polymer comprises at least one alkoxysilane group of formula (I): 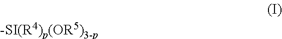
wherein:
R⁴ represents a linear or branched alkyl radical comprising from 1 to 4 carbon atoms, and when p is equal to 2, the R⁴ radicals are identical or different,
R⁵ represents a linear or branched alkyl radical comprising from 1 to 4 carbon atoms, and when p is equal to 0 or 1, the R⁵ radicals are identical or different, it being possible for two OR⁵ groups to be inserted in the same ring, and
p is an integer equal to 0, 1 or 2.

17. The composition as claimed in claim 15, wherein the silyl-modified polymer is of formula (II), (III) or (IV): 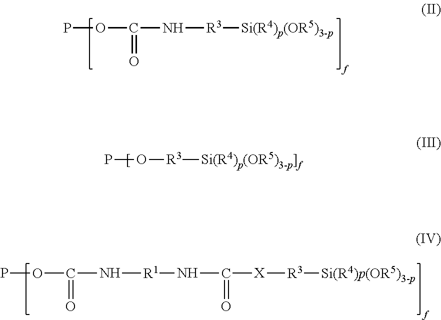
wherein:
R⁴, R⁵, and p have the same meaning as in formula (I) described above,
P represents a saturated or unsaturated polymer radical, with a linear or branched open chain, or comprising one or more optionally aromatic rings, optionally comprising one or more heteroatoms, and optionally comprising one or more ionic groups,
R¹ represents a saturated or unsaturated divalent hydrocarbon radical comprising from 5 to 15 carbon atoms, with a linear or branched open chain, or comprising one or more optionally aromatic rings,
R³ represents a linear or branched divalent alkylene radical comprising from 1 to 6 carbon atoms,
X represents a divalent radical chosen from —NH—, —NR⁷— or —S—,
R⁷ represents a linear or branched alkyl radical comprising from 1 to 20 carbon atoms and which may also comprise one or more heteroatoms,
f is an integer ranging from 1 to 6.

18. The composition as claimed in claim 17, wherein the silyl-modified polymer is of formula (II′), (II″), (III′) or (IV′): 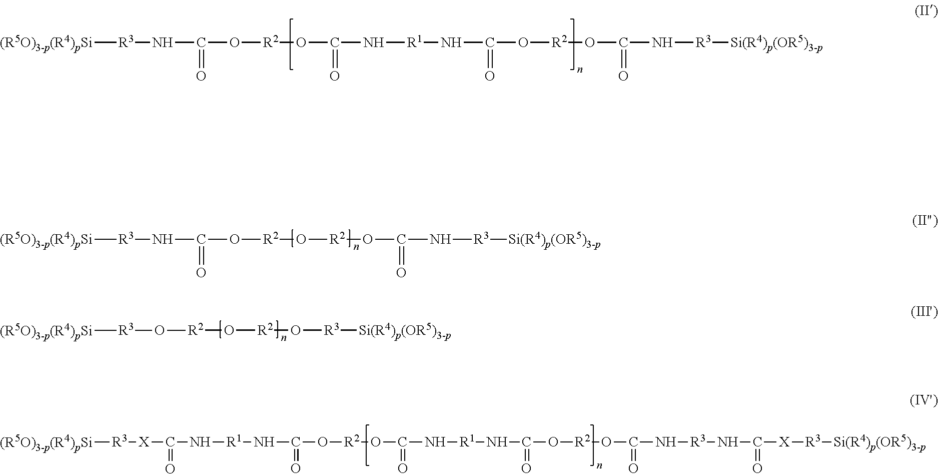
wherein:
R¹, R³, R⁴, R⁵, X, R⁷ and p have the same meaning as in formulae (II), (III) and (IV),
R² represents a linear or branched, saturated or unsaturated divalent hydrocarbon radical optionally comprising one or more heteroatoms, and optionally comprising one or more ionic groups,
n is an integer such that the number-average molar mass of the silyl-modified polymer is between 500 g/mol and 70000 g/mol.

19. The composition as claimed in claim 18, wherein the silyl-modified polymer is a polymer of formula (III′) and wherein:
R² represents an iso-propylene radical,
R⁴ and R⁵ each represent a methyl radical, and
p is equal to 1.

20. The composition as claimed in claim 15, wherein the carbon black content is at least 2% by weight relative to the total weight of the composition.

21. The composition as claimed in claim 15, wherein the rheological agent is one or more thixotropic agents.

22. The composition as claimed in claim 15, wherein the rheological agent is an amide wax and/or a wax derived from castor oil.

23. The composition as claimed in claim 15, further comprising at least one adhesion promoter chosen from amino-, mercapto- and epoxy-alkoxysilanes.

24. The composition as claimed in claim 23, wherein the at least one adhesion promoter is a mixture of at least two adhesion promoters.

25. The composition as claimed in claim 24, wherein the at least one adhesion promoter is a mixture of two adhesion promoters chosen from 4-amino-3,3-dimethylbutyltrimethoxysilane, (3-aminopropyl)trimethoxysilane, and n-butyl-3-aminopropyltrimethoxysilane.

26. A process for assembling two substrates by adhesive bonding, comprising:
the coating, onto at least one of the two substrates to be assembled, of the composition as claimed in claim 15; then
actually bringing the two substrates into contact.

27. An article capable of being obtained according to the assembly process of claim

26.

28. A sealant comprising the composition as claimed in claim 15.
